(19) United States
(12) Patent Application Publication
(10) Pub. No.: US 2019/0147674 A1
(43) Pub. Date: May 16, 2019

(54) DIGITAL DOOR LOCK SYSTEM AND CONTROL METHOD THEREOF

(71) Applicant: Dazayo Co., Ltd., Jeju-si (KR)

(72) Inventor: In Bok CHOI, Jeju-si (KR)

(73) Assignee: Dazayo Co., Ltd., Jeju-si (KR)

(21) Appl. No.: 15/824,226

(22) Filed: Nov. 28, 2017

(30) Foreign Application Priority Data
Nov. 16, 2017 (KR) 10-2017-0152767

(51) Int. Cl. G07C 9/00; G06Q 10/02

(52) U.S. Cl. CPC G07C 9/00103; G07C 9/00142; G06Q 10/02

(57) ABSTRACT

A digital door lock system includes a server adapted for managing reservation information and settlement information of guest rooms in a lodging establishment and information on digital door lock passwords in the lodging establishment; a user terminal communicating with the server to perform a reservation and a settlement of a guest room, transmit a digital door lock password directly set by a user to the server; and a door lock device adapted for receiving a digital door lock password from the server to store it and for opening and closing the digital door lock depending on whether the stored digital door lock password is matched with a password inputted by the user. The digital door lock system and a control method thereof allow the user to check in at a desired time and a provider for the establishment to cut down personnel expenses.

### TECHNICAL FIELD

The disclosure relates to a digital door lock system and a control method thereof, and more particularly, to a digital door lock system and a control method thereof, capable of directly setting a password of a digital door lock by a user of a guest room in a lodging establishment, resulting in that the user may check in at a desired time and a provider for the establishment may cut down personnel expenses.

### BACKGROUND

As an apparatus for opening and closing a guest room in a lodging establishment, a mechanical door lock has been commonly used to open and close the door using metal keys. However, such a mechanical door lock has a problem of poor security when a metal key used as the authentication means is lost or copied without permission.

In recent years, in order to solve the problems of the conventional mechanical door locks, the digital door locks have been developed and commercialized in which electronic keys are used as authentication means and microprocessors are mounted on the door locks to control opening and locking of the door locks.

However, in the case of a lodging establishment, there are problems in that steps of issuing and collecting a key must be accompanied, and it is impossible to access the door when a key or a password is lost. In addition, if the user is reluctant to disclose private information, there is an inconvenience to confront the manager of the lodging establishment.

In this regard, Korean Registration Patent No. 10-1218297, entitled “SYSTEM AND METHOD FOR CONTROLLING DOOR LOCK”, discloses a system and method for managing the opening/closing of a door lock in which the system includes a personal terminal connected to a management server and a door lock opening/closing controller connected to a door lock device such that the authentication of the user is passed through fingerprint authentication and the access obtained by the server authentication is determined by checking whether the one-time password obtained from the management server is valid or not.

In this way, the existing door lock system restricts the access of a passenger or passengers who have not been authenticated by the server, and the management server only manages the history of the entrance and exit of the passengers. Accordingly, there is a fear that the password may be lost because the user may not directly set the password.

Therefore, a technique for solving the above-described problems is required. Meanwhile, the above-described background description is information on technologies acquired by the inventor(s) for the purpose of deriving the disclosure or obtained in the process of deriving the disclosure, and can not necessarily be a known technology disclosed to the public prior to the filing of the disclosure.

### SUMMARY

In view of the foregoing, exemplary embodiments of the disclosure provides a digital door lock system and a control method thereof, capable of directly setting a password of a digital door lock by a user of a guest room in a lodging establishment, resulting in that the user may check in at a desired time and a provider for a lodging establishment may cut down personnel expenses.

Further, exemplary embodiments of the disclosure provides a digital door lock system and a control method thereof, capable of managing a reservation state of a guest room in a lodging establishment in real time and preventing a duplicated reservation, whereby a more convenient reservation service may be provided to the guest room user and a provider for the lodging establishment may reduce personnel expenses required for a management and reservation services of the guest room.

Further, exemplary embodiments of the disclosure provides a digital door lock system and a control method thereof, wherein when a security problem occurs, for example, a user input for setting a password is delayed or a password is incorrectly inputted, a temporary password is transmitted and a new password is inputted from the user, thereby providing more secure accommodation services.

In accordance with an aspect of the present disclosure, there is provided digital door lock system including: a server adapted for managing reservation information and settlement information of guest rooms in a lodging establishment and information on digital door lock passwords in the lodging establishment; a user terminal communicating with the server to perform a reservation and a settlement of the guest rooms, receive a digital door lock password directly set by a user, and transmit the digital door lock password to the server; and a door lock device adapted for receiving a digital door lock password from the server to store it and for opening and closing the digital door lock depending on whether the stored digital door lock password is matched with a password inputted by the user, characterized in that the server is configured to: switch state information of a guest room in which a reservation request is received to a reservation waiting state when the reservation request of the guest room is received from the user terminal, switch the state information of the guest room to a reservation completion state when a settlement is completed within a predetermined time, and request a user input for setting a digital door lock password to the user terminal, and the door lock device includes a beacon transmission/reception unit for identifying the user by transmitting/receiving a beacon signal to/from the user terminal.

In an embodiment of the digital door lock system, the server is configured to: transmit a temporary password to the door lock device and the user terminal when the password is not transmitted from the user terminal within a predetermined time after requesting the user input for setting the digital door lock password to the user terminal; and request a user input for resetting a digital door lock password to the user terminal.

In another embodiment of the digital door lock system, the server is configured to: transmit a temporary password to the door lock device and the user terminal when receiving information that the password has been erroneously inputted from the door lock device; and request a user input for resetting a digital door lock password to the user terminal.

In another embodiment of the digital door lock system of claim, the server is configured to: transmit a temporary password to the door lock device and the user terminal when information on the digital door lock passwords stored in the server is lost; and request a user input for resetting a digital door lock password to the user terminal.

In an embodiment of the digital door lock system, the server is configured to: transmit the temporary password to the door lock device and the user terminal when a user authentication is completed according to an authentication scheme selected by the user in performing the reservation and the settlement of the guest room.

In an embodiment of the digital door lock system, the temporary password transmitted by the server to the door lock device and the user terminal is a one-time password (OTP); and the server is configured to: recreate the one-time password to transmit it to the door lock device and the user terminal if after requesting the user input for resetting a digital door lock password to the user terminal, the digital door lock password is not transmitted from the user terminal within a predetermined time.

In a further embodiment, the digital door lock system further includes: a power control device for controlling a power to be supplied to the guest room when the digital door lock password directly set by the user in the door lock device or the temporary password transmitted by the server is inputted to the door lock device.

In an embodiment of the digital door lock system, the power control device is configured to: check whether the user goes out the guest room by transmitting/receiving the beacon signal from the beacon transmission/reception unit; and turn off the power of the guest room when it is checked that the user goes out or leaves the guest room.

In another embodiment of the digital door lock system, the server is configured to: initialize information on the digital door lock password stored in the server when a usage period of the guest room has elapsed.

In another embodiment of the digital door lock system, the door lock device is configured to output a warning message when the password has been erroneously inputted.

In accordance with another aspect of the present disclosure, there is provided a control method of a digital door lock system, includes: (a) receiving reservation information and settlement information of guest rooms in a lodging establishment from a user terminal; (b) receiving a digital door lock password directly set by a user from the user terminal; (c) transmitting the digital door lock password to a door lock device; and (d) identifying the user by transmitting/receiving a beacon signal to/from the user terminal, characterized in that the step (a) is performed by switching state information of the guest room in which a reservation request is received to a reservation waiting state when the reservation request of a guest room is received from the user terminal; switching the state information of the guest room to a reservation completion state when a settlement is completed within a predetermined time; and requesting a user input for setting a digital door lock password to the user terminal.

In an embodiment of the control method, the step (b) includes: (b-1) transmitting a temporary password to the door lock device and the user terminal when the password is not transmitted from the user terminal within a predetermined time after requesting the user input for setting the digital door lock password to the user terminal; and (b-2) requesting a user input for resetting a digital door lock password to the user terminal.

In a further embodiment, the control method further includes: (c-1) transmitting a temporary password to the door lock device and the user terminal when receiving information that the password has been erroneously inputted from the door lock device; and (f-1) requesting a user input for resetting a digital door lock password to the user terminal.

In a further embodiment, the control method further includes: (e-2) transmitting a temporary password to the door lock device and the user terminal when information on the digital door lock password is lost; and (f-2) requesting a user input for resetting a digital door lock password to the user terminal.

In an embodiment of the control method, the temporary password is transmitted to the door lock device and the user terminal when a user authentication is completed according to an authentication scheme selected by the user in performing of the reservation and the settlement of the guest room.

In an embodiment of the control method, the temporary password transmitted to the door lock device and the user terminal is a one-time password (OTP). In an embodiment, the control method further includes: recreating the one-time password to transmit it to the door lock device and the user terminal if after requesting the user input for resetting a digital door lock password to the user terminal, the digital door lock password is not transmitted from the user terminal within the predetermined time.

In a further embodiment, the control method further includes: controlling a power to be supplied to the guest room when the password directly set by the user or the temporary password transmitted by the server is inputted to the door lock device.

In a further embodiment, the control method further includes: checking whether the user goes out the guest room by transmitting/receiving the beacon signal; and turning off the power of the guest room when it is checked that the user goes out or leaves the guest room.

In a further embodiment, the control method further includes: initializing information on the digital door lock password stored in the server when a usage period of the guest room has elapsed.

In a further embodiment, the control method further includes: outputting a warning message when the password has been erroneously inputted.

As described above, in accordance with any one of the means for solving the problems of the above-mentioned disclosure, since the guest room user in the lodging establishment may directly set the digital door lock password, the guest room user may check in at a desired time, and the provider for the establishment may save personnel expenses.

Further, according to any one of the means for solving the problems of the above-mentioned disclosure, since the reservation state of the guest room in the lodging establishment may be managed in real time and the duplicated reservation may be prevented, a more convenient reservation service may be provided to the guest room user and the provider for the establishment may reduce personnel expenses required for the management and reservation service of the guest room,

In addition, according to any one of the means for solving the problems of the above-mentioned disclosure, since a temporary password is transmitted and a new password is inputted from the user when a security problem occurs, for example, a user input for setting a password is delayed or a password is incorrectly inputted, more secure accommodation service may be provided.

The effects of the disclosure are not limited to the aforementioned effects, and other effects not mentioned will be apparent to those skilled in the art from the following description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a digital door lock system in accordance with an embodiment of the disclosure;

FIG. 2 is a flowchart illustrating a control method of a digital door lock system according to an embodiment of the disclosure;

FIG. 3 is a flow chart illustrating a control method of a digital door lock system according to another embodiment of the disclosure; and

FIG. 4 is a flowchart illustrating a control method of a digital door lock system according to another embodiment of the disclosure.

### DETAILED DESCRIPTION

Hereinafter, embodiments of the present disclosure will be described in detail with reference to the accompanying drawings so that those skilled in the art can readily implement them. However, the present disclosure may be implemented in different forms, but it is not limited thereto. In the drawings, further, portions unrelated to the description of the present disclosure will be omitted for clarity of the description, and like reference numerals and like components refer to like elements throughout the detailed description.

In the entire specification, when a portion is “connected” to another portion, it means that the portions are not only “connected directly” with each other but they are electrically connected” with each other by way of another device therebetween. Further, when a portion “comprises” a component, it means that the portion does not exclude another component but further comprises other component unless otherwise described. Furthermore, it should be understood that one or more other features or numerals, steps, operations, components, parts or their combinations can be or are not excluded beforehand.

Hereinafter, specific embodiments of the present disclosure will be described in detail with reference to the drawings.

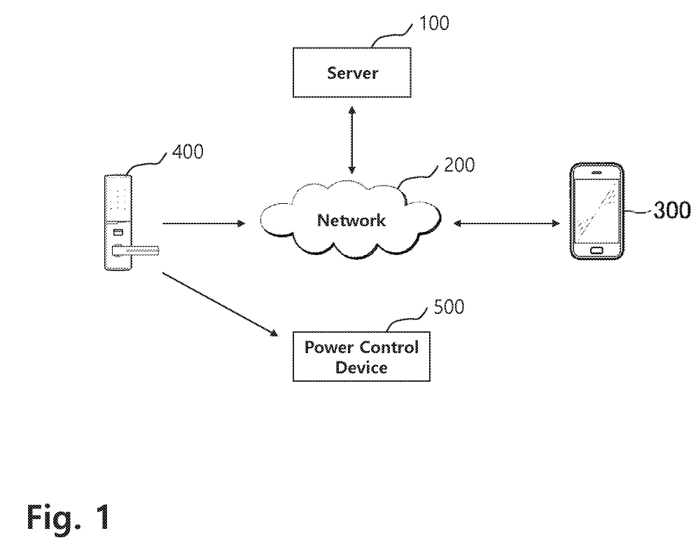

FIG. 1 is a block diagram illustrating a digital door lock system in accordance with an embodiment of the disclosure. As shown in FIG. 1, the digital door lock system according to the disclosure may include a server 100, a user terminal 300, and a door lock device 400. However, the digital door lock system of FIG. 1 is merely one embodiment of the disclosure, and thus the disclosure should not be interpreted as limited to FIG. 1.

The server 100, the user terminal 300, and the door lock device 400 constituting the digital door lock system according to the disclosure may be connected through a network 200.

As used herein, the network 200 refers to a connection structure in which information can be exchanged between nodes such as terminals and servers, and an example of the network 200 may include, but is not limited to, the Internet. The server 100, the user terminal 300, and the door lock device 400 shown in FIG. 1 are not interpreted as limited to those shown in FIG. 1.

The server 100 manages reservation information and settlement information of guest rooms in a lodging establishment, and information on digital door lock passwords. The server 100 may provide information related to a reservation and a settlement of a guest room through the user terminal 300. In addition, the server 100 may be connected to another server (not shown) via a wired/wireless communication network for the reservation and the settlement of the guest room. Herein, the other server may include an accommodation mediation server for transmitting the reservation information and the settlement information about the guest room in the lodging establishment from the plurality of users to the server 100.

The user terminal 300 communicates with the server 100 to perform the reservation and the settlement of the guest room, and receives a digital door lock password directly set by the user to transmit the digital door lock password to the server 100.

The user terminal 300 may be connected to the server 100 through the network 200 and may be implemented as a computer, a portable terminal device, a television, a wearable device, or the like, capable of connecting to another user terminal (not shown) or another server (not shown). For example, the computer may include a notebook, a desktop, a laptop, and the like on which a Web browser (WEB Browser) is mounted. The portable terminal device may include all kinds of handheld based wireless communication devices, for example, Personal Communication System (PCS), Personal Digital Cellular (PDC), Personal Handyphone System (PHS), Personal Digital Assistant (PDA), Global System for Mobile communications (GSM), International Mobile Telecommunication (IMT)-2000, Code Division Multiple Access (CDMA)-2000, W-Code Division Multiple Access(W-CDMA), Wireless Broadband Internet (Wibro), Smart Phone, Mobile Worldwide Interoperability for Microwave Access(WiMAX), which are wireless communication devices in which portability and mobility are ensured. In addition, the television may include Internet Protocol Television (IPTV), Internet Television, Terrestrial TV, Cable TV, and the like. Further, the wearable device may be an information processing apparatus of a type that may be directly worn on the human body, such as a watch, a pair of glasses, an accessory, a garment, a shoe and the like, and may be connected to the server 100 or another server (not shown), or to another user terminal (not shown) via a network 200, directly or through other information processing apparatus.

The door lock device 400 receives and stores a digital door lock password from the server 100 and opens or closes a door lock depending on whether the stored digital door lock password is matched with a password inputted by the user. The door lock device 400 may include a beacon transmission/reception unit adapted for identifying the user by transmitting/receiving a beacon signal to/from the user terminal.

The door lock may be a handle installed in a guest room door and may be formed inside and outside the door. In addition, the door lock may include an input unit for inputting a password and a display unit, an audio unit for sending a warning signal and a warning message, a communication unit for transmitting and receiving signals through the network 200, a memory unit storing the password and usage time of the guest room, and a control unit for determining whether to approve or reject the door lock according to whether or not a password entered by the user matches.

The server 100 may switch state information of the guest room in which a reservation request is received to a reservation waiting state when the reservation request of the guest room is received from the user terminal 300, may switch the state information of the guest room to a reservation completion state when a settlement is completed within a predetermined time, and may then request a user input for setting the digital door lock password to the user terminal 300. However, if the settlement is not completed within a predetermined time, the server 100 may determine again whether or not the settlement is completed within the predetermined time or cancel the reservation waiting state.

More specifically, the server 100 may receive an event such as a reservation search, a reservation request, a settlement request, etc. from the user terminal 300 and process the received events. For example, the server 100 may provide a reservation status of a lodging establishment in the whole country to a user terminal 300 in the form of an application or an Internet web site, and transmit information on the reservation or settlement to the manager of the corresponding lodging establishment when receiving a guest room reservation event and a rate settlement event of the reserved guest room through the user terminal 300. In this case, if the reservation request of the guest room is received from the user terminal 300, the reservation information may be prevented from being duplicated reservation by switching the state information of the guest room in which the reservation request is received to the reservation waiting state. In addition, if a settlement is completed within a predetermined time in the reservation waiting state, the settlement may be induced by switching the state information of the guest room to the reservation completion state, and the guest room in which the settlement event does not occur may be returned to a state in which the reservation is possible again. However, if the settlement is not completed within a predetermined time, the server 100 may determine again whether or not the settlement is completed within the predetermined time or cancel the reservation waiting state.

When the password is not transmitted from the user terminal 300 within the predetermined time after requesting a user input for setting a password of the digital door lock to the user terminal 300, the server 100 may transmit a temporary password to the door lock device 400 and the user terminal 300. Subsequently, the server 100 may request the user input for resetting a digital door lock password to the user terminal 300.

Further, the server 100 may transmit a temporary password to the door lock device 400 and the user terminal 300 when receiving information indicating that the password is incorrectly inputted from the door lock device 400, and request a user input for resetting a digital door lock password.

In addition, the server 100 may transmit a temporary password to the door lock device 400 and the user terminal 300 when a digital door lock password stored in the server 100 is lost and request a user input for resetting the digital door lock password to the user terminal 300

Moreover, the server 100 may transmit the temporary password to the door lock device 400 and the user terminal 300 only when the user authentication is completed according to the authentication scheme selected by the user in performing the reservation and the settlement of the guest room.

As an example, the temporary password transmitted by the server 100 to the door lock device 400 and the user terminal 300 may be a one-time password (OTP). In this case, the server 100 may recreate and transmit the one-time password to the door lock device 400 and the user terminal 300 if the password is not transmitted from the user terminal 300 within a predetermined time after requesting the user input for resetting the digital door lock password to the user terminal 300. In this way, the server 100 may continuously create the one-time password periodically according to an arbitrary rule when the password directly set by the user is not transmitted.

In this embodiment, a plurality of one-time passwords may be created at the same time. Also, the one-time password may be created based on the temporary password generated by the server 100. The server 100 may simultaneously transmit the plurality of one-time passwords to the user terminal 300 and an administrator terminal (not shown), or may simultaneously transmit one temporary password and one-time password generated based on the temporary password to the user terminal 300 and an administrator terminal (not shown) at the same time. The user terminal 300 may select a valid password among the plurality of one-time passwords by executing a pre-installed application. Furthermore, the temporary password and the one-time password generated based on the temporary password may be separately used for the administrator and the guest room user, respectively.

In addition, the one-time password may be generated by a combination of a time code portion based on the created time thereof and a user code portion assigned to each user. The one-time password generated in this manner may include reservation information and settlement information of the guest room and information on a guest room usage period through the execution of an application installed in advance on the user terminal 300 and the administrator terminal.

As described above, in the digital door lock system according to one embodiment of the disclosure, if there is a security problem such as a delay in user input for password setting or a wrong password input, a temporary password may be transmitted and a new password may be inputted from the user, and therefore, it is possible to provide a lodging service with further enhanced security.

Meanwhile, the digital door lock system according to one embodiment of the disclosure may further include a power control device 500 for controlling the power control device 500 to be supplied to the guest room when a password directly set by a user or a temporary password transmitted by the server 100 is inputted to the door lock device 400.

Specifically, the power control device 500 may check whether a user goes out guest room by transmitting/receiving the beacon signal to/from the beacon transmission/reception unit, and may turn off the power of the guest room when the user goes out or leaves the guest room. The power control device 500 may be designed to replace the conventional card key verification. Accordingly, when a guest room user normally enters the room, the power control device 500 supplies power to the guest room, and when the guest room user goes out or leaves the guest room, the waste of power may be prevented by turning off the power supply of the guest room.

Also, the server 100 may initialize information on a digital door lock password stored in the server 100 when a usage period of the guest room has elapsed. More specifically, the server 100 may initialize the digital door lock password information stored in the server 100 from the time when the usage period has elapsed by referring to the guest room usage period included in reservation information transmitted through the user terminal 300 and may switch the state of the guest room to a reservation enabled state.

In addition, the door lock device 400 may output a warning message when a password has been erroneously inputted. More specifically, the door lock device 400 may transmit door open/close information to the server 100, and output a warning message if a password transmitted from the server 100 is not matched with a password inputted through the door lock device 400 and inform the server 100 that an incorrect input event of the password has occurred. The server 100 may then notify to the user terminal 300 that the incorrect password input event of the password has occurred.

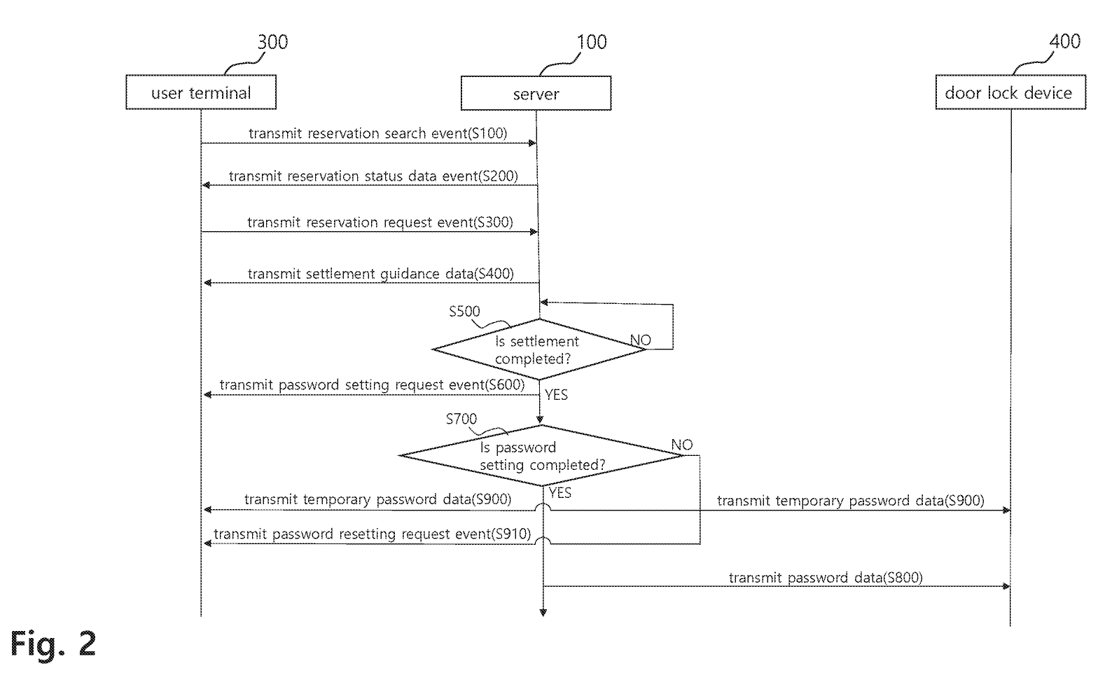

Hereinafter, a control method of the digital door lock system will be described in detail with reference to FIG. 2.

FIG. 2 is a flowchart illustrating a control method of a digital door lock system according to an embodiment of the disclosure. As shown in FIG. 2, the control method starts at S100 where a reservation search event is transmitted from the user terminal 300 to the server 100. The server 100 then transmits reservation status data to the user terminal 300 at S200.

Subsequently, when a reservation request event is transmitted from the user terminal 300 to the server 100 at S300, the server 100 transmits settlement guidance data to the user terminal 300 at S400. In this case, if the server 100 receives a reservation request of a guest room from the user terminal 300, the server 100 switches state information of the guest room where the reservation request is received to a reservation waiting state.

Next, the server 100 determines whether the settlement is completed within a predetermined time at 5500.When the settlement is completed within the predetermined time, the server 100 switches the state information of the guest room to the reservation completion state and transmits a password setting request event to the user terminal 300, at S600, in order to request a user input to set a password of the digital door lock to the user terminal 300. If, however, the settlement is not completed within the predetermined time, the server 100 may determine again whether or not the settlement is completed within the predetermined time or cancel the reservation waiting state.

More specifically, the server 100 may receive an event such as a reservation search, a reservation request, a settlement request, or the like from the user terminal 300 and process the received event. For example, the server 100 may present a reservation status of a lodging establishment in the whole country to the user terminal 300 in the form of an application or an Internet web site. In response, if there is a guest room reservation event or a rate settlement event of a reserved guest room which is received through the user terminal 300, the server 100 may transmit the reservation or settlement information to the manager of the corresponding lodging establishment. In this case, when the reservation request of the guest room is received from the user terminal 300, the reservation information may be prevented from being duplicated reservation in advance by switching the state information of the guest room in which the reservation request is received to the reservation waiting state. Also, if the settlement is completed within the predetermined time in the reservation waiting state, the settlement may be induced by switching the state information of the guest room to the reservation completion state, and the guest room in which the settlement event does not occur may be returned to a state in which the reservation is possible again. However, if the settlement is not completed within a predetermined time, the server 100 may determine again whether or not the settlement is completed within the predetermined time or cancel the reservation waiting state.

Subsequently, when the password is transmitted from the user terminal 300 within the predetermined time after requesting the user input to set a password of the digital door lock to the user terminal 300, the server 100 may transmit the password data of the digital door lock directly set by the user to the door lock device 400 at S800.

Meanwhile, when a password is not transmitted from the user terminal 300 within the predetermined time after requesting a user input for setting a digital door lock password to the user terminal 300, the server 100 may transmit a temporary password data to the door lock device 400 and the user terminal 300 at S900. After that, the server 100 transmits an event for requesting the user input for resetting the digital door lock password to the user terminal 300 at S910.

The control method of the digital door lock system according to an embodiment of the disclosure may further include identifying a user by transmitting/receiving a beacon signal to/from a user terminal.

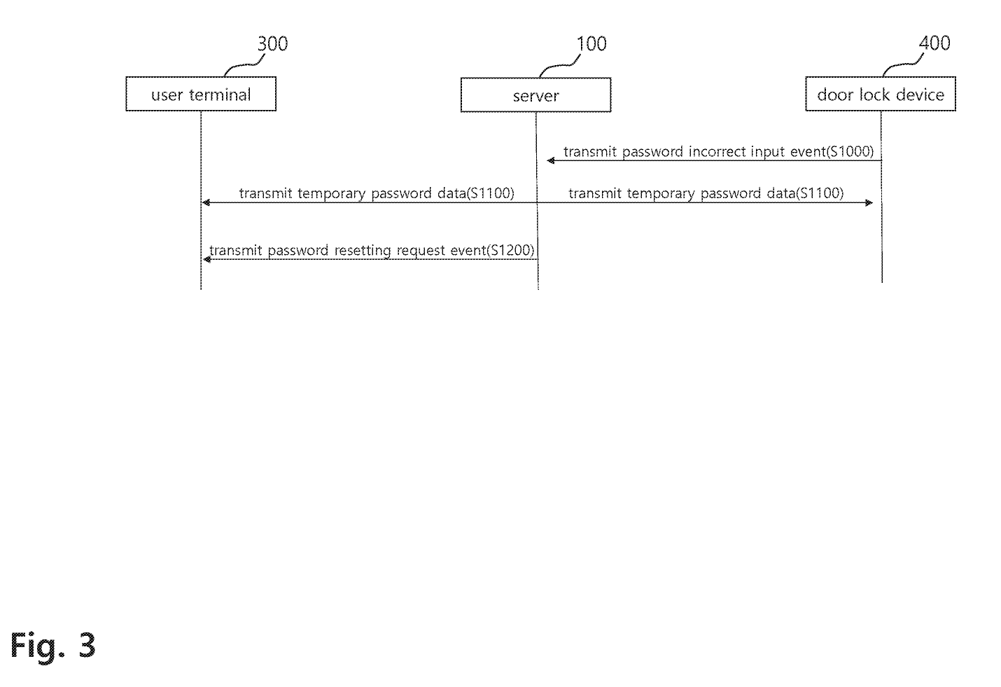

FIG. 3 is a flow chart illustrating a control method of a digital door lock system according to another embodiment of the disclosure. As shown in FIG. 3, the control method starts at S1000 where information indicating that the password is incorrectly inputted from the door lock device 400 is transmitted to the server 100. The server 100 then transmits a temporary password to the door lock device 400 and the user terminal 300 at S1100. Subsequently, the server 100 transmits an event requesting a user input for resetting a password of the digital door lock to the user terminal 300 at S1200.

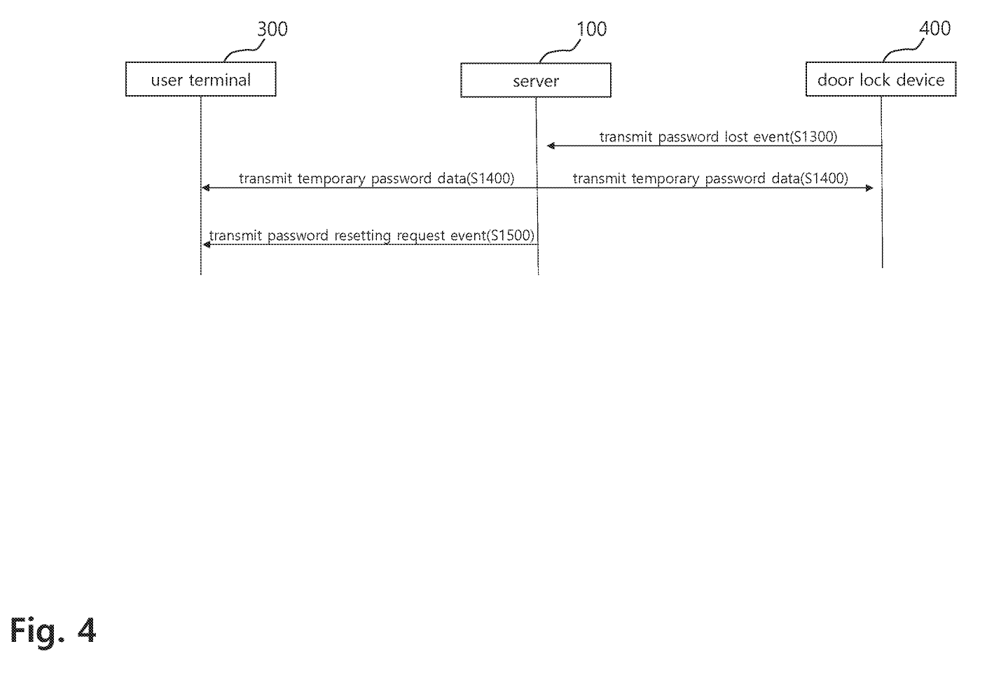

FIG. 4 is a flowchart illustrating a control method of a digital door lock system according to another embodiment of the disclosure. As shown in FIG. 4, the control method starts at S1300 where information indicating that the password of the door lock device has lost is transmitted from the door lock device 400 to the server 10. The server 100 then transmits a temporary password to both the door lock device 400 and the user terminal 300 at S1100. Subsequently, the server 100 transmits an event requesting a user input for resetting a password of the digital door lock to the user terminal 300 at step S1500.

Herein, the temporary password may be transmitted to both the door lock device 400 and the user terminal 300 when the user authentication is completed according to the authentication scheme selected by the user in a process for performing the reservation and settlement of the guest room.

Further, the temporary password transmitted to the door lock device and the user terminal may be a one-time password (OTP), and the control method of the digital door lock system according to embodiments of the disclosure may further include recreating and transmitting the one-time password to the door lock device 400 and the user terminal 300 if the password is not transmitted from the user terminal 300 within a predetermined time after requesting the user input for resetting the digital door lock password to the user terminal 300.

As such, the server 100 may continuously create the onetime password periodically according to an arbitrary rule when the password directly set by the user is not transmitted.

Herein, a plurality of one-time passwords may be created at the same time. Also, the one-time password may be created based on the temporary password generated by the server 100. The server 100 may simultaneously transmit the plurality of one-time passwords to the user terminal 300 and an administrator terminal (not shown), or may transmit one temporary password and one-time password generated based on the temporary password to the user terminal 300 and an administrator terminal (not shown) at the same time. The user terminal 300 may select a valid password among the plurality of onetime passwords by executing a pre-installed application. In addition, the temporary password and the one-time password generated based on the temporary password may be separately used for the administrator and the guest room user, respectively.

Further, the one-time password may be generated by a combination of a time code portion based on the created time thereof and a user code portion assigned to each user. The one-time password generated in this manner may include reservation information and settlement information of the guest room, and information on a guest room usage period through the execution of an application already installed on the user terminal 300 and the administrator terminal.

Accordingly, in accordance with the control method of the digital door lock system according to one embodiment of the disclosure, if there is a security problem such as a delay in a user input or an incorrect password input for setting a password, a temporary password may be transmitted and a new password may be inputted from the user, and therefore, it is possible to provide a lodging service with further enhanced security.

Meanwhile, the control method of the digital door lock system according to one embodiment of the disclosure may further include supplying power to the guest room when the password directly set by a user or the temporary password transmitted by the server is inputted to the door lock device 400, and turning off the power of the guest room when the user goes out or leaves the guest room. In this case, the power control device 400 may check whether a user goes out by transmitting/receiving a beacon signal to/from the beacon transmission/reception unit, and may turn off the power of the guest room when the user goes out or leaves the guest room.

This is to replace the conventional card key verification. Accordingly, when a guest room user normally enters the room, the power is supplied to the guest room, and when the guest room user goes out or leaves the guest room, the waste of power may be prevented by turning off the power supply of the guest room.

In addition, the control method of the digital door lock system according to the one embodiment of the disclosure may further include initializing the information on the digital door lock password stored in the server when a usage period of the guest room has elapsed. More specifically, the server 100 may initialize the password information stored in the server 100 from the time when the usage period has elapsed by referring to the guest room usage period included in the reservation information transmitted through the user terminal 300 and may switch the state of the guest room to a reservation enabled state.

In addition, the control method of the digital door lock system according to the one embodiment of the disclosure may further include outputting a warning message when the password has been erroneously inputted. More specifically, the door lock device 400 may transmit door open/close information to the server 100, and output a warning message if a password transmitted from the server 100 is not matched with a password inputted through the door lock device 400 and transmit to the server 100 that an incorrect input event of the password has occurred. And, the server 100 may transmit to the user terminal 300 a fact that the incorrect password input event of the password has occurred.

The control method of the digital door lock according to the embodiments of the present disclosure as described above may be executed by a program (which may include a program included in a platform or operating system that is basically installed in the server) installed on the server. In this sense, the control method of the digital door lock according to the embodiments of the present disclosure may be implemented as a program installed in the server basically or directly installed by a user, and may be recorded in a computer-readable recording medium.

Description of the present disclosure as mentioned above is intended for illustrative purposes, and it will be understood to those having ordinary skill in the art that this disclosure can be easily modified into other specific forms without changing the technical idea and the essential characteristics of the present disclosure. Accordingly, it should be understood that the embodiments described above are exemplary in all respects and not limited thereto. For example, respective components described to be one body may be implemented separately from one another, and likewise components described separately from one another may be implemented in an integrated type.

The scope of the present disclosure is represented by the claims described below rather than the foregoing detailed description, and it should be construed that all modifications or changes derived from the meaning and scope of the claims and their equivalent concepts are intended to be fallen within the scope of the present disclosure.

1. A digital door lock system comprising:
a server adapted for managing reservation information and settlement information of guest rooms in a lodging establishment and information on digital door lock passwords in the lodging establishment;
a user terminal communicating with the server to perform a reservation and a settlement of the guest rooms, receive a digital door lock password directly set by a user, and transmit the digital door lock password to the server; and
a door lock device adapted for receiving a digital door lock password from the server to store it and for opening and closing the digital door lock depending on whether the stored digital door lock password is matched with a password inputted by the user,
characterized in that the server is configured to:
switch state information of a guest room in which a reservation request is received to a reservation waiting state when the reservation request of the guest room is received from the user terminal, switch the state information of the guest room to a reservation completion state when a settlement is completed within a predetermined time, and request a user input for setting a digital door lock password to the user terminal; and
the door lock device includes a beacon transmission/reception unit for identifying the user by transmitting/receiving a beacon signal to/from the user terminal.

2. The digital door lock system of claim 1, wherein the server is configured to:
transmit a temporary password to the door lock device and the user terminal when the password is not transmitted from the user terminal within a predetermined time after requesting the user input for setting the digital door lock password to the user terminal; and
request a user input for resetting a digital door lock password to the user terminal.

3. The digital door lock system of claim 1, wherein the server is configured to:
transmit a temporary password to the door lock device and the user terminal when receiving information that the password has been erroneously inputted from the door lock device; and
request a user input for resetting a digital door lock password to the user terminal.

4. The digital door lock system of claim 1, wherein the server is configured to:
transmit a temporary password to the door lock device and the user terminal when information on the digital door lock passwords stored in the server is lost; and
request a user input for resetting a digital door lock password to the user terminal.

5. The digital door lock system of claim 2, wherein the server is configured to:
transmit the temporary password to the door lock device and the user terminal when a user authentication is completed according to an authentication scheme selected by the user in performing the reservation and the settlement of the guest room.

6. The digital door lock system of claim 2, wherein the temporary password transmitted by the server to the door lock device and the user terminal is a one-time password (OTP); and
the server is configured to:
recreate the one-time password to transmit it to the door lock device and the user terminal if after requesting the user input for resetting a digital door lock password to the user terminal, the digital door lock password is not transmitted from the user terminal within a predetermined time.

7. The digital door lock system of claim 2, further comprising:
a power control device for controlling a power to be supplied to the guest room when the digital door lock password directly set by the user in the door lock device or the temporary password transmitted by the server is inputted to the door lock device.

8. The digital door lock system of claim 2, wherein the power control device is configured to:
check whether the user goes out the guest room by transmitting/receiving the beacon signal from the beacon transmission/reception unit; and
turn off the power of the guest room when it is checked that the user goes out or leaves the guest room.

9. The digital door lock system of claim 1, wherein the server is configured to:
initialize information on the digital door lock password stored in the server when a usage period of the guest room has elapsed.

10. The digital door lock system of claim 1, wherein the door lock device is configured to output a warning message when the password has been erroneously inputted.

11. A control method of a digital door lock system, comprising:
(a) receiving reservation information and settlement information of guest rooms in a lodging establishment from a user terminal;
(b) receiving a digital door lock password directly set by a user from the user terminal;
(c) transmitting the digital door lock password to a door lock device; and
(d) identifying the user by transmitting/receiving a beacon signal to/from the user terminal, characterized in that
the step (a) is performed by switching state information of the guest room in which a reservation request is received to a reservation waiting state when the reservation request of a guest room is received from the user terminal; switching the state information of the guest room to a reservation completion state when a settlement is completed within a predetermined time; and requesting a user input for setting a digital door lock password to the user terminal.

12. The control method of claim 11, wherein the step (b) comprises:
(b-1) transmitting a temporary password to the door lock device and the user terminal when the password is not transmitted from the user terminal within a predetermined time after requesting the user input for setting the digital door lock password to the user terminal; and
(b-2) requesting a user input for resetting a digital door lock password to the user terminal.

13. The control method of claim 11, further comprising:
(e-1) transmitting a temporary password to the door lock device and the user terminal when receiving information that the password has been erroneously inputted from the door lock device; and
(f-1) requesting a user input for resetting a digital door lock password to the user terminal.

14. The control method of claim 11, further comprising:
(e-2) transmitting a temporary password to the door lock device and the user terminal when information on the digital door lock password is lost; and
(f-2) requesting a user input for resetting a digital door lock password to the user terminal.

15. The control method of claim 12, wherein the temporary password is transmitted to the door lock device and the user terminal when a user authentication is completed according to an authentication scheme selected by the user in performing of the reservation and the settlement of the guest room.

16. The control method of claim 12, wherein the temporary password transmitted to the door lock device and the user terminal is a one-time password (OTP), and
the method further comprises:
recreating the one-time password to transmit it to the door lock device and the user terminal if after requesting the user input for resetting a digital door lock password to the user terminal, the digital door lock password is not transmitted from the user terminal within the predetermined time.

17. The control method of claim 12, further comprising:
controlling a power to be supplied to the guest room when the password directly set by the user or the temporary password transmitted by the server is inputted to the door lock device.

18. The control method of claim 17, further comprising:
checking whether the user goes out the guest room by transmitting/receiving the beacon signal; and
turning off the power of the guest room when it is checked that the user goes out or leaves the guest room.

19. The control method of claim 11, further comprising:
initializing information on the digital door lock password stored in the server when a usage period of the guest room has elapsed.

20. The control method of claim 11, further comprising:
outputting a warning message when the password has been erroneously inputted.
